(19) United States
(12) Patent Application Publication
(10) Pub. No.: US 2011/0142519 A1
(43) Pub. Date: Jun. 16, 2011

(54) TAPE PRINTER, METHOD FOR CONTROLLING TAPE PRINTER, AND COMPUTER PROGRAM PRODUCT

(75) Inventor: Hideyuki TSUKUDA, Matsumoto-shi (JP)

(73) Assignee: Seiko Epson Corporation, Tokyo (JP)

(21) Appl. No.: 12/967,468

(22) Filed: Dec. 14, 2010

(30) Foreign Application Priority Data
Dec. 15, 2009 (JP) 2009-283743

(51) Int. Cl. B41J 11/44

(52) U.S. Cl. 400/76

(57) ABSTRACT

A tape printer printing an image on a tape, the tape printer includes: an operation accepting section accepting an entry operation; a display section performing screen display based on the entry operation accepted by the operation accepting section; an illuminating section illuminating the display section; a control section controlling the operation of the tape printer; and a printing section printing the image based on an entered character string on the tape, wherein while the printing section performs printing based on the entry operation, the control section switches a mode to the first power-saving mode in which the illuminating section is turned off.

### CROSS-REFERENCE

The present application claims priority from Japanese Patent Application No. 2009-283743 filed on Dec. 15, 2009, which is hereby incorporated by reference in its entirety.

In the past, a tape printer provided with a display section for displaying an image of an entered character string or the like has been known. Some of such tape printers have a display section provided with illumination such as a backlight for better viewability.

Moreover, an information display device has been disclosed which switches into a power-saving state by turning off a backlight of a display device (a display section) such as a liquid crystal monitor when the user does not perform selection operation for more than a previously set wait time while a selection screen that makes the user make a selection is displayed (for example, Japanese Patent Publication No.2009-20416 (Patent Document 1)). With such an information display device, it is possible to reduce power consumption of the display device.

However, even when the function of turning off the illumination (the backlight) of the display section is applied to the tape printer, satisfactory power saving is not realized because the power consumed by the parts other than the illumination is not reduced. It is against this background that a tape printer that can further reduce power consumption has been sought after.

### SUMMARY

Various embodiments may solve at least part of the problems described above, and the invention can be realized as an embodiment or an application example described below.

### Application Example 1

According to at least one embodiment of the disclosure, there is provided a tape printer printing an image on a tape, the tape printer including: an operation accepting section accepting an entry operation; a display section performing screen display based on the entry operation accepted by the operation accepting section; an illuminating section illuminating the display section; a control section controlling the operation of the tape printer; and a printing section printing the image based on an entered character string on the tape, wherein while the printing section performs printing based on the entry operation, the control section switches a mode to a first power-saving mode in which the illuminating section is turned off.

According to such a tape printer, the operation accepting section accepts an entry operation. The display section performs screen display based on the entry operation. The illuminating section illuminates the display section. While the printing section performs printing, the control section switches a mode to a first power-saving mode in which the illuminating section is turned off. As a result, since the illuminating section is turned off while printing during which it is not necessary to accept an entry operation by the user, it is possible to reduce power consumption.

### Application Example 2

In the tape printer according to the application example described above, further including: a power supply circuit switching a power supply of the tape printer on and off, wherein the control section switches a mode to the first power-saving mode in which the illuminating section is turned off when the operation accepting section does not accept any entry operation for a first period, and switches a mode to a second power-saving mode in which the power supply of the power supply circuit is turned off when the operation accepting section does not accept any entry operation for a second period which is longer than the first period.

According to such a tape printer, the power supply circuit switches the power supply of the tape printer on and off. The control section switches a mode to the first power-saving mode in which the illuminating section is turned off when no entry operation is accepted for a first period. Moreover, the control section switches a mode to a second power-saving mode in which the power supply of the power supply circuit is turned off when no entry operation is accepted for a second period which is longer than the first period. As a result, since the illuminating section is turned off when no entry operation is accepted for the first period, it is possible to reduce power consumption. Moreover, since the power supply of the tape printer is turned off when no entry operation is accepted for the second period which is longer than the first period, it is possible to reduce further power consumption.

### Application Example 3

In the tape printer according to the application example described above, the control section may switch a mode to a third power-saving mode in which the screen display of the display section is stopped when the operation accepting section does not accept any entry operation for a third period which is longer than the first period and shorter than the second period.

According to such a tape printer, the control section switches a mode to a third power-saving mode in which the screen display of the display section is stopped when no entry operation is accepted for the third period. This makes it possible to make the power consumption lower than that in the first power-saving mode without turning off the power supply of the tape printer unlike in the second power-saving mode.

### Application Example 4

The tape printer according to the application example described above may further include a period changing section changing at least one of the first period, the second period, and the third period according to a predetermined entry operation accepted by the operation accepting section.

According to such a tape printer, the period changing section changes at least one of the first period, the second period, and the third period according to a predetermined entry operation. This allows the user to set the first period, the second period, and the third period at an intended period.

### Application Example 5

According to at least one embodiment of the disclosure, there is provided a method for controlling a tape printer including a display section performing screen display based on an entry operation, an illuminating section illuminating the display section, and a printing section printing an image based on an entered character string on a tape, the method including: (a) accepting an entry operation; (b) switching a mode to the first power-saving mode in which the illuminating section is turned off, while the printing section prints the image based on the entry operation.

According to such a method for controlling a tape printer, while the printing section performs printing, the control section switches a mode to the first power-saving mode in which the illuminating section is turned off. As a result, since the illuminating section is turned off while printing during which it is not necessary to accept an entry operation by the user, it is possible to reduce power consumption.

### Application Example 6

According to at least one embodiment of the disclosure, there is provided a computer program product for making a computer execute the steps of the method for controlling a tape printer, the method described in the application example described above.

By making the computer execute such a program product, the illuminating section is turned off when no entry operation is accepted for the first period in the operation accepting step, whereby it is possible to reduce power consumption. Moreover, since the power supply of the tape printer is turned off when no entry operation is accepted for the second period which is longer than the first period, it is possible to reduce further power consumption.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is a perspective view showing a tape printer of a first embodiment.

FIG. 2 is a perspective view showing the tape printer of the first embodiment.

FIG. 3 is a block diagram showing a circuit configuration of the tape printer.

FIG. 4 is a state transition diagram of the tape printer.

FIGS. 5A to 5D are explanatory diagrams showing the screen of a display section in each state of the tape printer,

FIG. 5A being an explanatory diagram showing the screen in a standby state, FIG. 5B being an explanatory diagram showing the screen in a character entry state, FIG. 5C being an explanatory diagram showing the screen in a backlight unlit state, and FIG. 5D being an explanatory diagram showing the screen in a printing state.

FIG. 6 is a flowchart of processing in a standby state of the tape printer.

FIG. 7 is a flowchart of processing in a character entry state of the tape printer.

FIG. 8 is a flowchart showing processing in a backlight unlit state of the tape printer.

FIG. 9 is a flowchart of processing in a printing state of the tape printer.

FIGS. 10A to 10C are explanatory diagrams showing a menu screen displayed on a display section of the tape printer,

FIG. 10A being an explanatory diagram of a menu screen for changing a first period for which a backlight is unlit, FIG. 10B being an explanatory diagram of a menu screen for making lighting settings of the backlight in a printing state, and FIG. 10C being an explanatory diagram of a menu screen for changing the intensity of the backlight.

FIG. 11 is an explanatory diagram showing a second period change menu screen.

FIG. 12 is a state transition diagram of a tape printer of a second embodiment.

FIG. 13 is an explanatory diagram showing the screen of a display section in a display stopped state of the tape printer.

FIG. 14 is a flowchart of processing in a backlight unlit state of the tape printer.

FIG. 15 is a flowchart of processing in a display stopped state of the tape printer.

FIG. 16 is an explanatory diagram showing a third period change menu screen.

### DESCRIPTION OF EMBODIMENTS

Hereinafter, embodiments will be described.

### First Embodiment

In a first embodiment, a tape printer which switches into a first power-saving mode when the tape printer does not accept an entry operation for a first period and switches into a second power-saving mode when the tape printer does not accept an entry operation for a second period will be described with reference to the drawings.

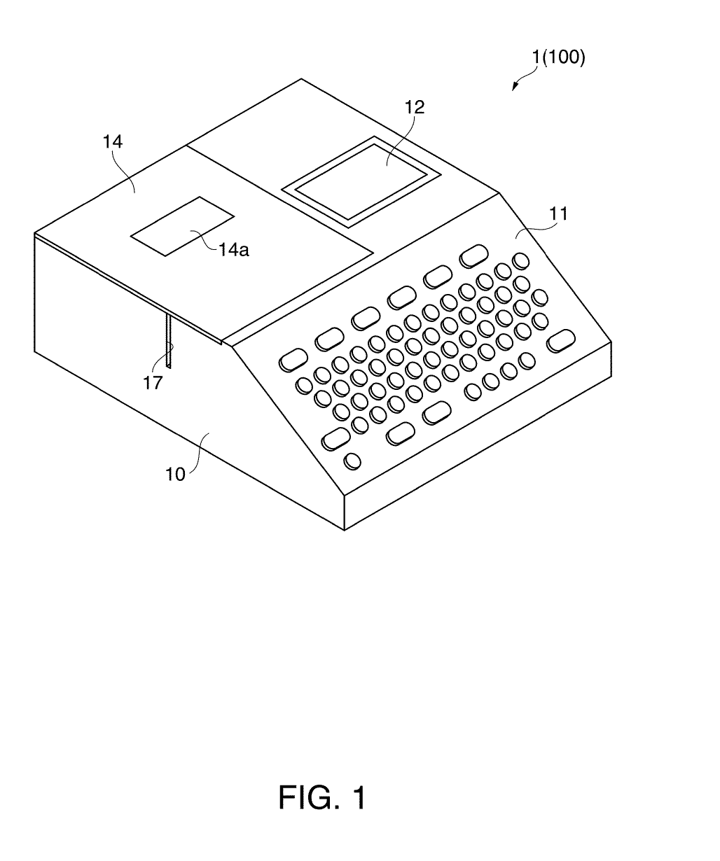

FIGS. 1 an 2 are perspective views showing a tape printer of the first embodiment.

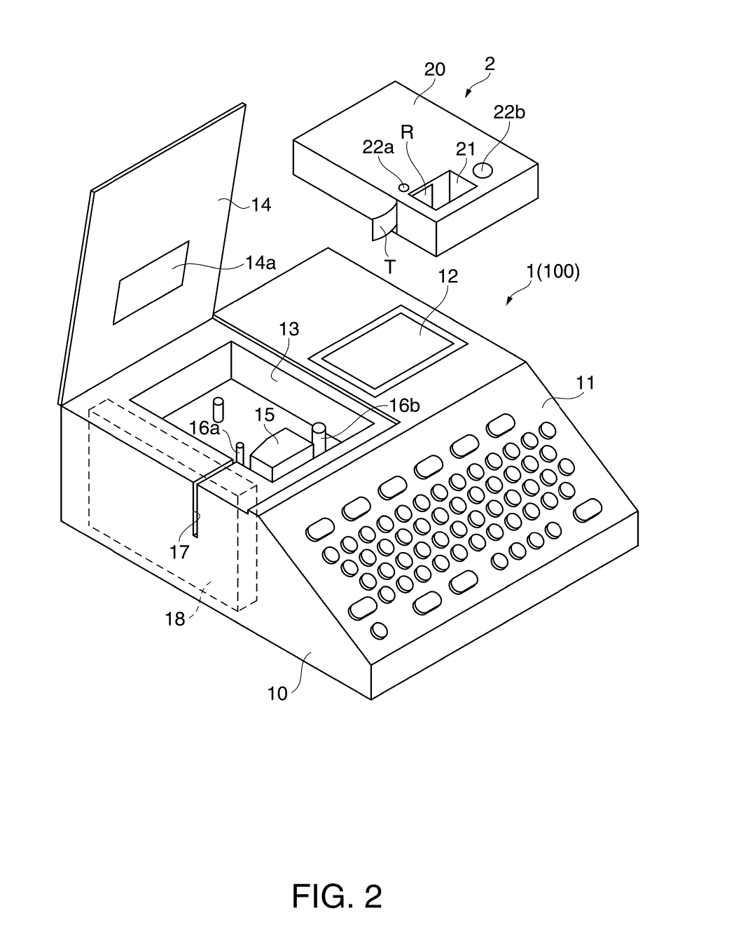

As shown in FIGS. 1 and 2, a tape printer 1 has a structure in which a main body is housed in a cabinet 10, and the cabinet 10 has a keyboard 11 on the front upper face thereof. The keyboard 11 is an entry section which accepts various entry operations, such as an entry of a character string, performed by the user, and has a large number of character keys by which a character string composed of a kana character, a kanji character, an alphabet, a numeric, a symbol, etc. can be entered and a plurality of control keys for giving an instruction of various operations to the tape printer 1. The control keys of the keyboard 11 include a power supply key for switching a power supply on and off, a conversion key for converting entered kana characters into a kanji character, an Enter key for confirming the entered character string or the like, a cursor key used, for example, to move a cursor, a print key for performing printing, a menu key for displaying a menu screen, etc.

The cabinet 10 has a display section 12 on the upper face thereof near the back, the display section 12 formed of a liquid crystal display device and the like. The display section 12 forms an image with a large number of pixels arranged in a matrix, and is used to display a character entered from the keyboard 11 and display a menu screen and a message screen.

On the back of the display section 12, a backlight (which is not shown in FIGS. 1 and 2) serving as an illuminating section for illuminating the display section 12 is provided. The backlight 46 is, for example, an illuminating device formed of an LED (light emitting diode). When the backlight 46 is turned on, the display section 12 is illuminated.

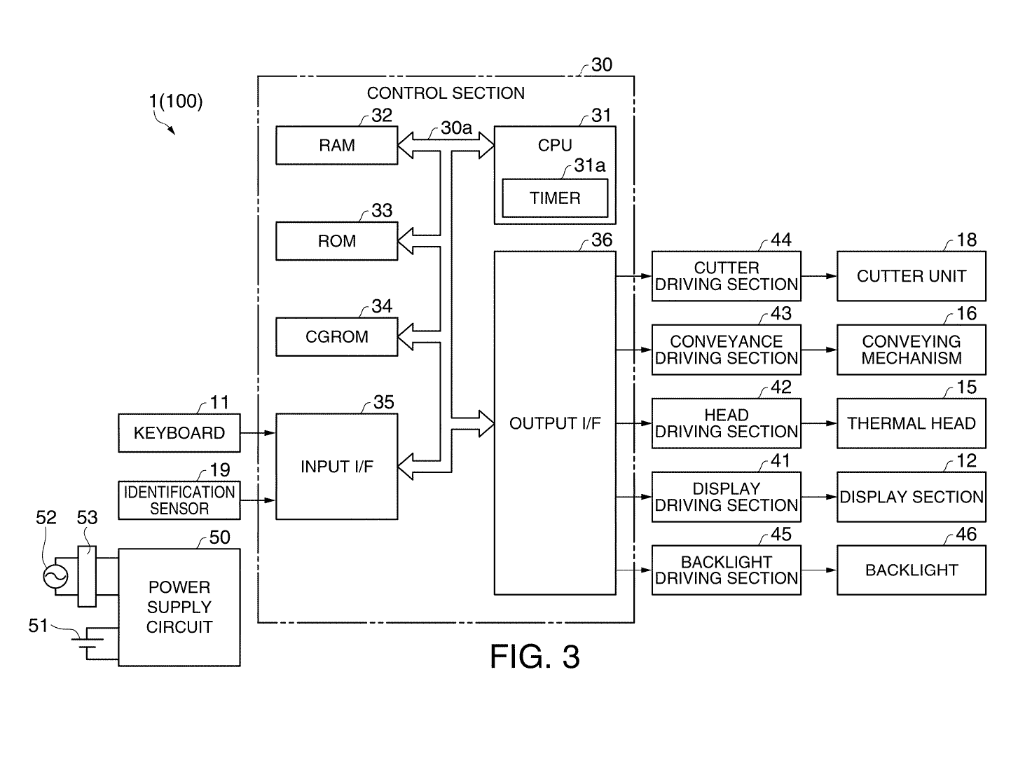

Next to the display section 12, the cabinet 10 has a concave portion 13 formed on the upper face thereof near the back, the concave portion 13 into which a tape cartridge 2 is placed. On the opening of the concave portion 13, an opening and closing lid 14 is provided so as to be openable and closable, and, by bringing the opening and closing lid 14 into an open state, the tape cartridge 2 can be attached and detached. Moreover, the opening and closing lid 14 has a translucent confirmation window 14a, which allows the user to check visually and externally whether or not the tape cartridge 2 is placed in the concave portion 13. At the bottom of the concave portion 13, a thermal head 15 and rotating shafts 16a and 16b forming a conveying mechanism 16 (see FIG. 3) are provided. When the tape cartridge 2 is placed into the concave portion 13, the thermal head 15 fits into a hole-shaped head fit portion 21 provided in the tape cartridge 2, and the rotating shafts 16a and 16b are engaged in hole-shaped driven sections 22a and 22b, respectively.

The tape cartridge 2 has a built-in tape T and a built-in ink ribbon R, of which both are belt-shaped, in a cartridge case 20. The tape T is a printing medium of the tape printer 1, and has a structure in which an adhesive layer is formed on the back of a base material formed of PET (polyethylene terephthalate) or paper material and the adhesive layer is coated with release paper. The tape printer 1 can support two or more types of tape cartridge 2 which differ in width, material (material of the base material), color, etc. of the tape T, and the user can use a tape cartridge 2 according to the use or preference. Incidentally, on the back of the tape cartridge 2, a plurality of holes (not shown) are provided for identifying the built-in tape T, whereby the tape printer 1 can identify the tape type of the tape cartridge 2 placed in the concave portion 13 by an identification sensor 19 (see FIG. 3), such as a microswitch, provided on the bottom of the concave portion 13.

When the tape cartridge 2 is placed into the concave portion 13, the front surface of the tape T faces the thermal head 15 in the head fit portion 21 with the ink ribbon R placed between the tape T and the thermal head 15. The thermal head 15 has a large number of heater elements (not shown) formed therein, the heater elements arranged in line in a direction perpendicular to the longitudinal direction (the direction in which the tape T is conveyed) of the tape T, and selectively makes each heater element generate heat, whereby the ink of the ink ribbon R is transferred (thermally transferred) to the front surface of the tape T. That is, a dot is formed on the front surface of the tape T in a position corresponding to the heater element which has generated heat. Here, when the rotating shafts 16a and 16b are driven and rotated, the tape T and the ink ribbon R are conveyed, the tape T is then ejected to the outside of the cartridge case 20, and the ink ribbon R is reeled in in the cartridge case 20. Then, by repeating the above-described thermal transfer while gradually conveying the tape T and the ink ribbon R, an image formed of a plurality of dots is printed on the front surface of the tape T.

In a side face of the cabinet 10, a slit 17 which makes the outside of the cabinet 10 and the concave portion 13 communicate with each other is provided, and the printed tape T ejected from the cartridge case 20 passes through the slit 17, and a predetermined length thereof is conveyed toward the outside of the cabinet 10. Inside the cabinet 10, a cutter unit 18 for cutting the tape T crossing the slit 17 is provided. The printed part of the tape T is cut by the cutter unit 18, and is ejected out of an opening (a tape ejection port) of the slit 17 as a tape piece (a label).

FIG. 3 is a block diagram showing a circuit configuration of the tape printer 1.

As shown in FIG. 3, in addition to the keyboard 11, the display section 12, the thermal head 15, the conveying mechanism 16 including the rotating shafts 16a and 16b (see FIG. 2), the cutter unit 18, the backlight 46, and the identification sensor 19 which have been described above, the tape printer 1 includes a control section 30 which performs centralized control of the operation of the tape printer 1, a display driving section 41 which makes the display section 12 display an image, a head driving section 42 which drives the thermal head 15 and makes the thermal head 15 generate heat, a conveyance driving section 43 which drives the conveying mechanism 16, a cutter driving section 44 which drives the cutter unit 18, a backlight driving section 45 for making the backlight 46 illuminate, a power supply circuit 50, etc.

The control section 30 functions as a computer, and has a CPU (central processing unit) 31, RAM (random access memory) 32, ROM (read only memory) 33, CGROM (character generator ROM) 34, an input interface (I/F) 35, an output interface (I/F) 36, and the like, which are connected with each other via a bus 30a.

The CPU 31 operates in accordance with a control program product stored in the ROM 33, and controls various operations of the whole of the tape printer 1. Moreover, the CPU 31 includes a timer 31a. The timer 31a measures time according to an instruction from the CPU 31.

The RAM 32 is a storage section formed of volatile memory, and temporarily stores various processing results of the CPU 31, a character code string entered from the keyboard 11, display image data to be displayed by the display section 12, printing image data to be printed by the thermal head 15, etc. Moreover, the RAM 32 also stores document data and the like which are formed of a character code string. Incidentally, the document data and the like may be stored in flash memory or the like which is nonvolatile memory.

The ROM 33 and the CGROM 34 are storage sections formed of nonvolatile memory such as mask ROM or flash memory, and the ROM 33 stores the above-described control program product, various data, and the like.

The CGROM 34 stores font data of characters which can be printed by the tape printer 1. The font data is data in the bit map format, the data for generating a character to be printed by the thermal head 15 and a character to be displayed by the display section 12. The font data in the bit map format is formed of a large number of dots, and each dot corresponds to the heater element of the thermal head 15 and the pixel of the display section 12. The CGROM 34 stores font data of a plurality of fonts, and the CPU 31 acquires corresponding font data from the CGROM 34 by specifying a font type, a character size, and a character code, and generates display image data and printing image data by using this font data. Incidentally, as the font data, font data in an outline format, which is easily related to various character sizes, may be used.

To the input interface 35, the keyboard 11 and the identification sensor 19 are connected. When the keyboard 11 is operated by the user, the keyboard 11 accepts this operation as entry operation, and outputs key information corresponding to the operated key to the CPU 31 via the input interface 35. Here, the keyboard 11, the input interface 35, and the CPU 31 correspond to an operation accepting section. Moreover, the identification sensor 19 outputs identification information according to the tape type of the tape cartridge 2 placed in the concave portion 13 to the CPU 31 via the input interface 35.

To the output interface 36, the display driving section 41, the head driving section 42, the conveyance driving section 43, the cutter driving section 44, and the backlight driving section 45 are connected, and these sections drive the display section 12, the thermal head 15, the conveying mechanism 16, the cutter unit 18, and the backlight 46, respectively, based on the control from the CPU 31. The backlight 46 is controlled to be turned on and off by the backlight driving section 45. Moreover, the intensity of the backlight 46 when it is lit is also controlled by the backlight driving section 45.

The power supply circuit 50 supplies power to individual parts of the tape printer 1 or stops power supply thereto by using a battery 51 or a commercial power supply (an alternating-current power supply) 52 as a power supply. That is, the power supply circuit 50 turns on and off the power supply of the tape printer 1. The power supply circuit 50 is provided with a battery terminal (not shown) for connecting (mounting) the battery 51 and a power supply terminal (not shown) for connecting an AC adapter 53 which converts the commercial power supply 52 into a direct-current power supply, and at least one of the battery 51 and the AC adapter 53 is connected to the terminal. Incidentally, the battery 51 may be a primary battery or a secondary battery, and other batteries such as a fuel battery may be adopted.

In the tape printer 1 configured as described above, when the power supply key is operated by the user, the tape printer 1 starts operating by using the battery 51 or the commercial power supply 52 as a power supply, whereby characters can be entered by means of the character keys, and various instructions can be given by means of the control keys.

Here, when a character is entered as a result of the character key being operated by the user, the keyboard 11 accepts this entry, and outputs key information to the control section 30. Based on the key information input from the keyboard 11, the control section 30 identifies a character code of the entered character, and stores the character code in the RAM 32. Then, the control section 30 acquires font data corresponding to the character code from the CGROM 34, and generates display image data by using the font data thus acquired. When the control section 30 supplies the display image data to the display driving section 41, the entered character is displayed on the display section 12. Then, when the user repeats an entry of a character multiple times, a character code string (text data) including a plurality of character codes is stored in the RAM 32, and a character string formed of a plurality of characters is displayed on the display section 12.

When the print key is operated by the user after the character (the character string) is entered, the tape printer 1 performs printing processing.

Hereinafter, operation processing of the tape printer 1 will be described.

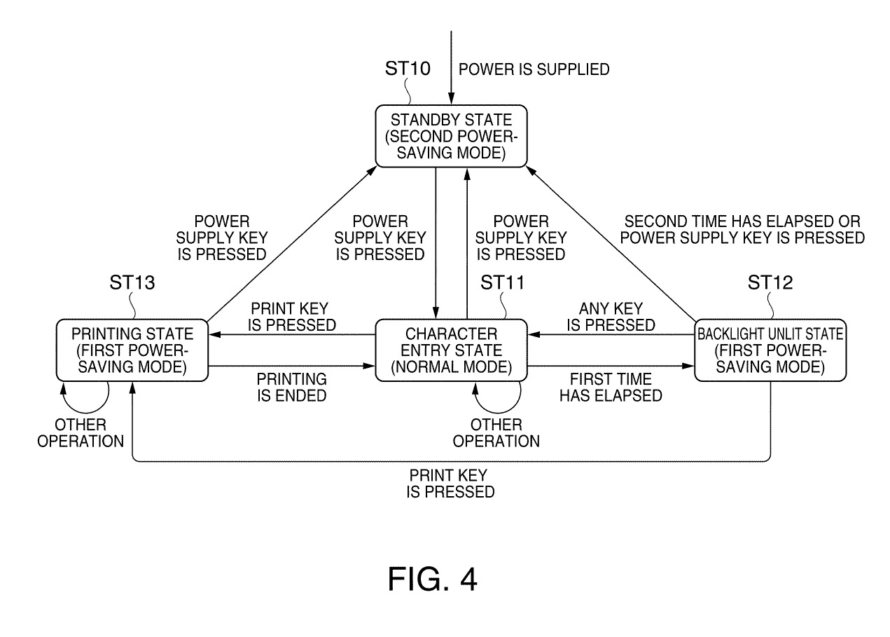

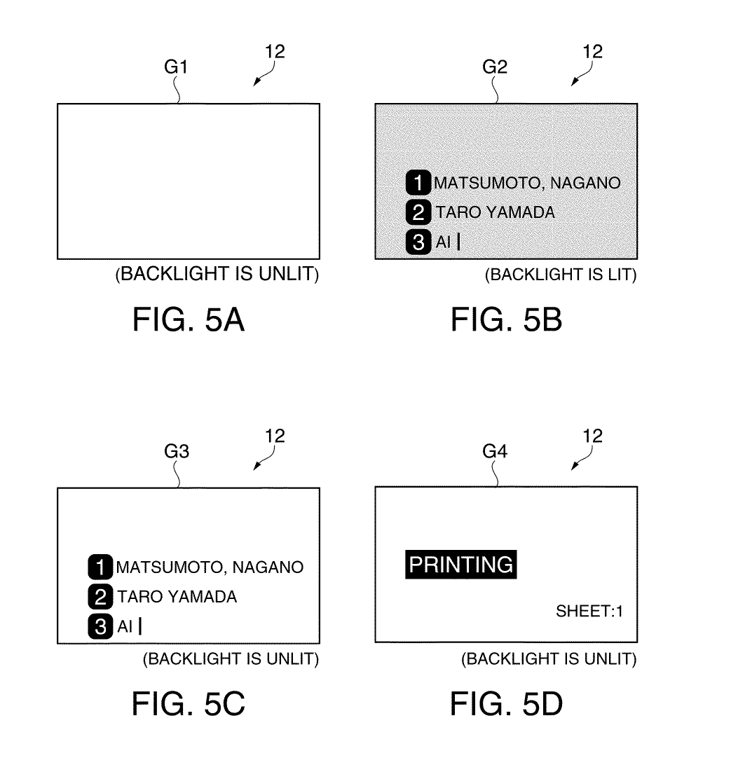

First, state transition of the tape printer 1 will be described by using a state transition diagram and explanatory diagrams of a screen. FIG. 4 is a state transition diagram of the tape printer 1 according to this embodiment. FIGS. 5A to 5D are explanatory diagrams showing the screen of the display section 12 in each state of the tape printer 1, FIG. 5A is an explanatory diagram showing the screen in a standby state ST10, FIG. 5B is an explanatory diagram showing the screen in a character entry state ST11, FIG. 5C is an explanatory diagram showing the screen in a backlight unlit state ST12, and FIG. 5D is an explanatory diagram showing the screen in a printing state ST13.

As shown in FIG. 4, the tape printer 1 can transition to the standby state ST10, the character entry state ST11, the backlight unlit state ST12, and the printing state ST13.

Moreover, each state is in any one of a normal mode, a first power-saving mode, and a second power-saving mode. In the normal mode, the power supply circuit 50 supplies power, the display section 12 performs screen display, and the backlight 46 is lit. In the first power-saving mode, the power supply circuit 50 supplies power, the display section 12 performs screen display, and the backlight 46 is unlit. In the second power-saving mode, the power supply circuit 50 stops the supply of power, the display section 12 stops screen display, and the backlight 46 is unlit.

When the tape printer 1 is supplied with power by the battery 51 or the commercial power supply 52, the tape printer 1 enters the standby state ST10. In the standby state ST10, the tape printer 1 is in the second power-saving mode, and waits for power supply ON operation to be performed. In the standby state ST10, the display section 12 is a nondisplay screen G1 on which nothing is displayed. As shown in FIG. 5A, nothing is displayed on the nondisplay screen G1, and the backlight 46 is unlit. When the power supply key of the keyboard 11 is pressed in the standby state ST10, the tape printer 1 transitions to the character entry state ST11.

In the character entry state ST11, the tape printer 1 is in the normal mode, and turns on the backlight 46 and accepts a character entry. In the character entry state ST11, a character entry screen G2 is displayed on the display section 12. As shown in FIG. 5B, a character string entered by the user is displayed on the character entry screen G2, and the backlight 46 is lit.

When the print key of the keyboard 11 is pressed in the character entry state ST11, the tape printer 1 transitions to the printing state ST13. Moreover, when the power supply key of the keyboard 11 is pressed in the character entry state ST11, the tape printer 1 transitions to the standby state ST10. Furthermore, when no key is pressed and the value measured by the timer 31a exceeds a first period in the character entry state ST11, the tape printer 1 transitions to the backlight unlit state ST12. In this embodiment, the first period is assumed to be 20 seconds. Moreover, when any other key of the keyboard 11 is pressed in the character entry state ST11, the tape printer 1 does not transition to any state.

In the backlight unlit state ST12, the tape printer 1 is in the first power-saving mode, and turns off the backlight 46 and accepts a character entry. In the backlight unlit state ST12, a character entry screen G3 in which the backlight is unlit is displayed on the display section 12. As shown in FIG. 5C, a character string entered by the user is displayed on the character entry screen G3 in which the backlight is unlit.

When the print key of the keyboard 11 is pressed in the backlight unlit state ST12, the tape printer 1 transitions to the printing state ST13. Moreover, when the power supply key of the keyboard 11 is pressed in the backlight unlit state ST12, the tape printer 1 transitions to the standby state ST10. Furthermore, when no key is pressed and the value measured by the timer 31a exceeds a second period in the backlight unlit state ST12, the tape printer 1 transitions to the standby state ST10. In this embodiment, the second period is assumed to be 5 minutes. Moreover, when any other key of the keyboard 11 is pressed in the backlight unlit state ST12, the tape printer 1 transitions to the character entry state ST11.

In the printing state ST13, the tape printer 1 is in the first power-saving mode, and turns off the backlight 46 and performs printing. In the printing state ST13, a printing state screen G4 is displayed on the display section 12. As shown in FIG. 5D, a character string indicating that printing is being performed and the number of sheets of paper on which printing is performed are displayed on the printing state screen G4, and the backlight 46 is unlit.

When the power supply key of the keyboard 11 is pressed in the printing state ST13, the tape printer 1 transitions to the standby state ST10. Moreover, when printing is ended in the printing state ST13, the tape printer 1 transitions to the character entry state ST11. Furthermore, when any of the keys of the keyboard 11 other than the power supply key is pressed in the printing state ST13, the tape printer 1 does not transition to any state.

Next, processing in each state of the tape printer 1 will be described.

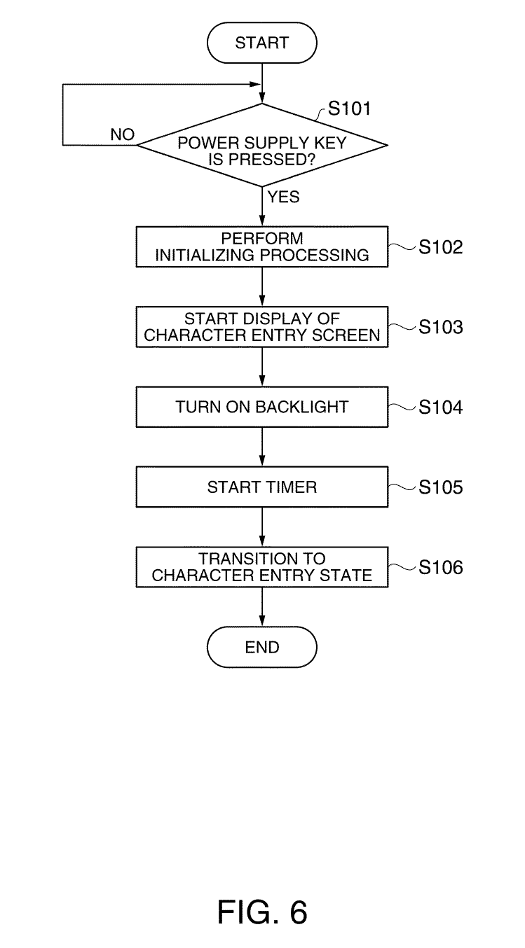

FIG. 6 is a flowchart of processing in the standby state ST10 of the tape printer 1.

In the standby state ST10, the control section 30 determines whether or not the power supply key of the keyboard 11 is pressed to perform power supply ON operation (step S101). If the power supply key is not pressed (step S101: NO), the control section 30 repeatedly performs the process in step S101, and waits for the power supply key to be pressed.

If the power supply key is pressed (step S101: YES), the control section 30 performs initializing processing (step S102). In this embodiment, as the initializing processing, initialization of the CPU 31 and initialization of memory such as the RAM 32 are performed. Moreover, initialization of other software and hardware is performed. Next, the control section 30 gives an instruction to the display driving section 41 to make the display section 12 start display of the character entry screen (step S103).

The control section 30 gives an instruction to the backlight driving section 45 to turn on the backlight 46 (step S104). Next, the control section 30 starts the timer 31a (step S105). Then, the control section 30 makes the tape printer 1 transition to the character entry state ST11 (step S106). Then, the control section 30 ends the processing of the tape printer 1 in the standby state ST10.

Next, processing in the character entry state ST11 will be described.

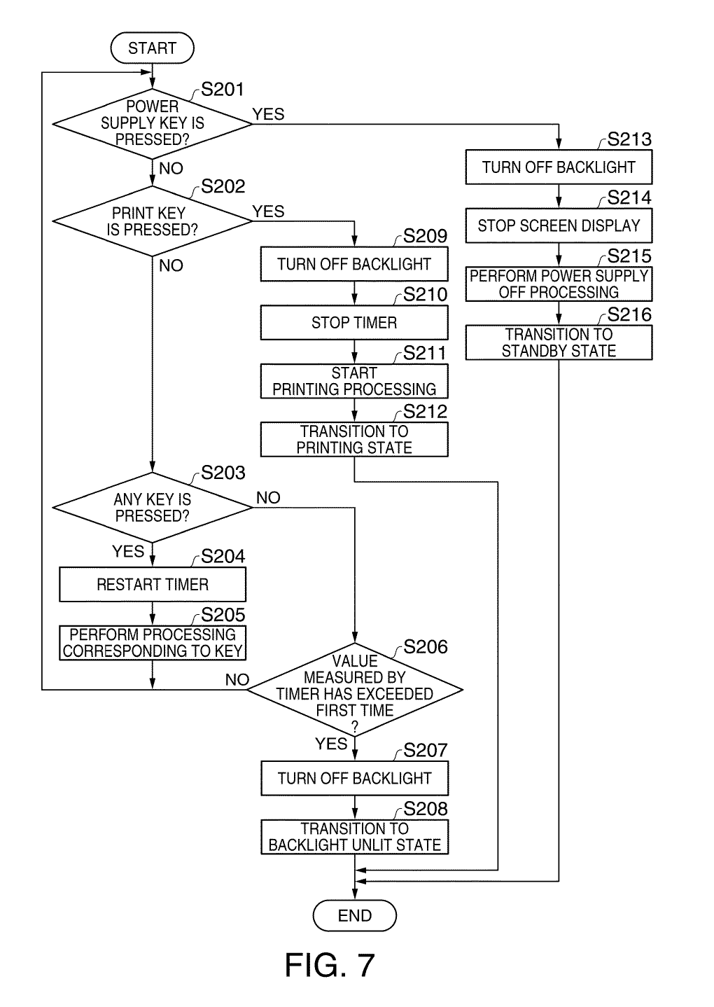

FIG. 7 is a flowchart of processing in the character entry state ST11 of the tape printer 1.

In the character entry state ST11, the control section 30 determines whether or not the power supply key of the keyboard 11 is pressed to perform power supply OFF operation (step S201). If the power supply key is not pressed (step S201: NO), the control section 30 determines whether or not the print key of the keyboard 11 is pressed (step S202). If the print key is not pressed (step S202: NO), the control section 30 determines whether or not any of the keys of the keyboard 11 is pressed (step S203).

If any of the keys is pressed (step S203: YES), the control section 30 restarts the timer 31a (step S204). That is, the control section 30 starts the timer 31a from “0”. Then, the control section 30 performs processing corresponding to the pressed key (step S205). The processing corresponding to the pressed key is, for example, character entry processing by the character key or control processing by the control key. Then, the procedure goes back to step S201.

If none of the keys is pressed (step S203: NO), the control section 30 determines whether or not the value measured by the timer 31a has exceeded the first period (step S206). If the value has not exceeded the first period (step S206: NO), the procedure goes back to step S201.

If the value has exceeded the first period (step S206: YES), the control section 30 gives an instruction to the backlight driving section 45 to turn off the backlight 46 (step S207). Then, the control section 30 makes the tape printer 1 transition to the backlight unlit state ST12 (step S208). Then, the control section 30 ends the processing of the tape printer 1 in the character entry state ST11.

If the print key is pressed (step S202: YES), the control section 30 gives an instruction to the backlight driving section 45 to turn off the backlight 46 (step S209). Then, the control section 30 stops the timer 31a (step S210).

The control section 30 starts printing processing based on the entered character string (step S211). Specifically, in the printing processing, the control section 30 generates printing image data based on the character code string stored in the RAM 32, and the head driving section 42 and the conveyance driving section 43 drive the thermal head 15 and the conveying mechanism 16, respectively, based on the printing image data, and thereby printing an image according to the printing image data on the tape T. Then, the control section 30 makes the cutter driving section 44 drive the cutter unit 18, and the cutter unit 18 cuts the tape T. Incidentally, the control section 30, the head driving section 42, the conveyance driving section 43, the thermal head 15, and the conveying mechanism 16 at the time of the printing processing correspond to a printing section.

By starting the printing processing described above, the control section 30 makes the tape printer 1 transition to the printing state ST13 (step S212). Then, the control section 30 ends the processing of the tape printer 1 in the character entry state ST11.

If the power supply key is pressed (step S201: YES), the control section 30 controls the backlight driving section 45 to turn off the backlight 46 (step S213). Then, the control section 30 controls the display driving section 41 to stop screen display (step S214). Furthermore, the control section 30 performs power supply OFF processing (step S215). In this embodiment, the power supply OFF processing is processing performed along with power supply OFF of the tape printer 1, and includes processing of software or hardware corresponding to the power supply OFF. Then, the control section 30 makes the tape printer 1 transition to the standby state ST10 (step S216). The control section 30 then ends the processing of the tape printer 1 in the character entry state ST11.

Next, processing in the backlight unlit state ST12 will be described.

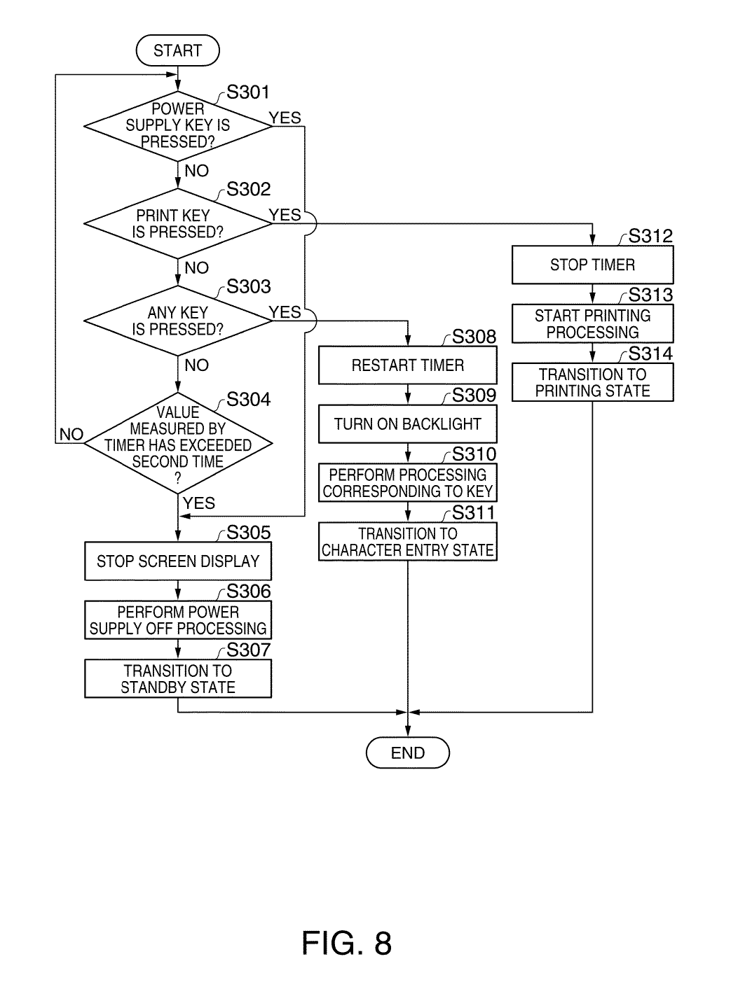

FIG. 8 is a flowchart of processing in the backlight unlit state ST12 of the tape printer 1.

In the backlight unlit state ST12, the control section 30 determines whether or not the power supply key of the keyboard 11 is pressed to perform power supply OFF operation (step S301). If the power supply key is not pressed (step S301: NO), the control section 30 determines whether or not the print key of the keyboard 11 is pressed (step S302). If the print key is not pressed (step S302: NO), the control section 30 determines whether or not any of the keys of the keyboard 11 is pressed (step S303).

If none of the keys is pressed (step S303: NO), the control section 30 determines whether or not the value measured by the timer 31a has exceeded the second period (step S304). If the value has not exceeded the second period (step S304: NO), the procedure goes back to step S301.

If the value has exceeded the second period (step S304: YES), the control section 30 gives an instruction to the display driving section 41 to stop screen display (step S305). The control section 30 performs power supply OFF processing (step S306). Then, the control section 30 makes the tape printer 1 transition to the standby state ST10 (step S307). The control section 30 then ends the processing of the tape printer 1 in the backlight unlit state ST12.

If any of the keys is pressed (step S303: YES), the control section 30 restarts the timer 31a (step S308). Then, the control section 30 makes the backlight driving section 45 turn on the backlight 46 (step S309).

The control section 30 performs processing corresponding to the pressed key (step S310). Then, the control section 30 makes the tape printer 1 transition to the character entry state ST11 (step S311). The control section 30 then ends the processing of the tape printer 1 in the backlight unlit state ST12.

If the print key is pressed (step S302: YES), the control section 30 stops the timer 31a (step S312). Then, the control section 30 starts printing processing based on the entered character string (step S313). Then, the control section 30 makes the tape printer 1 transition to the printing state ST13 (step S314), and ends the processing of the tape printer 1 in the backlight unlit state ST12.

If the power supply key is pressed (step S301: YES), the procedure proceeds to step S305, and the control section stops screen display and performs power supply OFF processing, and thereby making the tape printer 1 transition to the standby state ST10. Then, the control section 30 ends the processing of the tape printer 1 in the backlight unlit state ST12.

Next, processing in the printing state ST13 will be described.

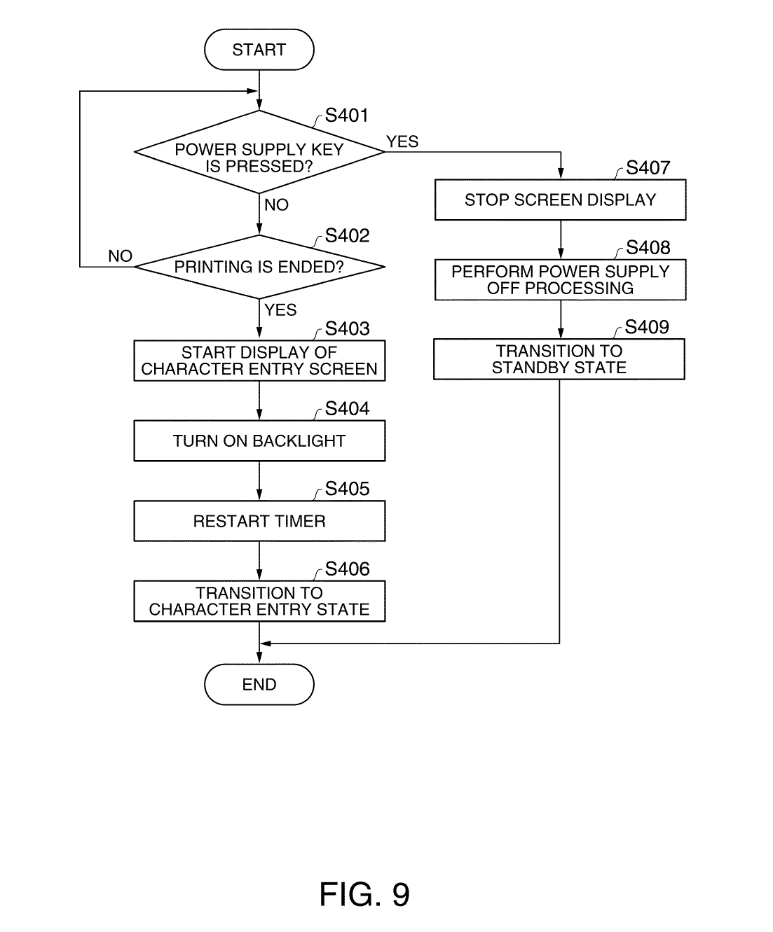

FIG. 9 is a flowchart of processing in the printing state ST13 of the tape printer 1.

In the printing state ST13, the control section 30 determines whether or not the power supply key of the keyboard 11 is pressed to perform power supply OFF operation (step S401). If the power supply key is not pressed (step S401: NO), the control section 30 determines whether or not the printing processing is ended (step S402). If the printing processing is not ended (step S402: NO), the procedure goes back to step S401.

If the printing processing is ended (step S402: YES), the control section 30 gives an instruction to the display driving section 41 to make the display section 12 start display of the character entry screen (step S403). Then, the control section 30 gives an instruction to the backlight driving section 45 to turn on the backlight 46 (step S404).

The control section 30 restarts the timer 31a (step S405). Then, the control section 30 makes the tape printer 1 transition to the character entry state ST11 (step S406). The control section 30 then ends the processing of the tape printer 1 in the printing state ST13.

If the power supply key is pressed (step S401: YES), the control section 30 gives an instruction to the display driving section 41 to stop screen display (step S407). Then, the control section 30 performs power supply OFF processing (step S408). Then, the control section 30 makes the tape printer 1 transition to the standby state ST10 (step S409). The control section 30 then ends the processing of the tape printer 1 in the printing state ST13.

As described above, the tape printer 1 can transition to/from the standby state ST10, the character entry state ST11, the backlight unlit state ST12, and the printing state ST13.

Next, various settings related to the backlight 46 of the tape printer 1 will be described. In the tape printer 1 of this embodiment, the first period for which the backlight 46 is unlit can be changed. Moreover, in the tape printer 1, it is possible to make settings as to whether the backlight 46 is turned on or not in the printing state ST13. Furthermore, in the tape printer 1, the intensity of the backlight 46 can be changed.

These settings related to the backlight 46 are made as follows: the tape printer 1 makes the display section 12 display the independent menu screens, and the user presses the cursor key or the Enter key of the keyboard 11.

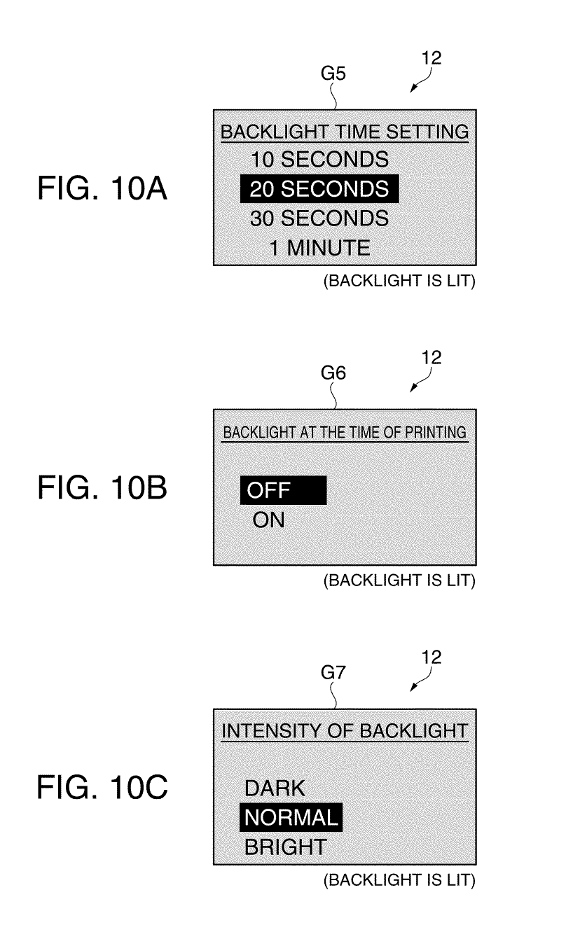

FIGS. 10A to 10C are explanatory diagrams showing a menu screen displayed on the display section 12 of the tape printer 1, FIG. 10A is an explanatory diagram of a menu screen for changing the first period for which the backlight 46 is unlit, FIG. 10B is an explanatory diagram of a menu screen for making lighting settings of the backlight 46 in the printing state ST13, and FIG. 10C is an explanatory diagram of a menu screen for changing the intensity of the backlight 46.

FIG. 10A is a first period change menu screen G5. In the uppermost part of the first period change menu screen G5, the character string of “BACKLIGHT TIME SETTING” indicating that this is a first period change menu is displayed. Under that character string, from the top, the character strings of “10 SECONDS”, “20 SECONDS”, “30 SECONDS”, and “1 MINUTE” are displayed as options. In the first period change menu screen G5, the part corresponding to the current setting of “20 SECONDS” is highlighted as a cursor.

When the user presses the cursor key of the keyboard 11, the highlighted cursor is moved up and down. Then, the user can set the currently highlighted option as a first period by pressing the Enter key. The control section 30 stores the set first period in the RAM 32. The control section 30 here corresponds to a period changing section. Incidentally, in this embodiment, the default of the first period is “20 SECONDS”.

The control section 30 of the tape printer 1 controls the backlight 46 in the character entry state ST11 by referring to the first period stored in the RAM 32 in the manner as described above.

FIG. 10B is a printing-time backlight setting menu screen G6. In the uppermost part of the printing-time backlight setting menu screen G6, the character string of “BACKLIGHT AT THE TIME OF PRINTING” indicating that this is a printing-time backlight setting menu is displayed. Under that character string, from the top, the character strings of “OFF” and “ON” are displayed as options. In the printing-time backlight setting menu screen G6, the part corresponding to the current setting of “OFF” is highlighted as a cursor.

When the user presses the cursor key of the keyboard 11, the highlighted cursor is moved up and down. Then, the user can set the currently highlighted option by pressing the Enter key. The control section 30 stores the set printing-time backlight setting in the RAM 32. Incidentally, in this embodiment, the default of the printing-time backlight setting is “OFF”.

The control section 30 of the tape printer 1 controls the backlight 46 in the printing state ST13 by referring to the printing-time backlight setting stored in the RAM 32 in the manner as described above.

FIG. 10C is a backlight intensity setting menu screen G7. In the uppermost part of the backlight intensity setting menu screen G7, the character string of “INTENSITY OF BACKLIGHT” indicating that this is a backlight intensity setting menu is displayed. Under that character string, from the top, the character strings of “DARK”, “NORMAL”, and “BRIGHT” are displayed as options. In the backlight intensity setting menu screen G7, the part corresponding to the current setting of “NORMAL” is highlighted as a cursor.

When the user presses the cursor key of the keyboard 11, the highlighted cursor is moved up and down. Then, the user can set the currently highlighted option as the intensity of the backlight by pressing the Enter key. The control section 30 stores the set intensity of the backlight in the RAM 32. Incidentally, in this embodiment, the default of the intensity of the backlight is “NORMAL”.

The control section 30 of the tape printer 1 controls the intensity of the backlight 46 by giving an instruction to the backlight driving section 45 by referring to the backlight intensity setting stored in the RAM 32 in the manner as described above.

Moreover, in the tape printer 1 of this embodiment, the second period can also be changed. As is the case with the first period change menu screen G5, the tape printer 1 makes the display section 12 display a second period change menu screen, and the user can select and set an intended period.

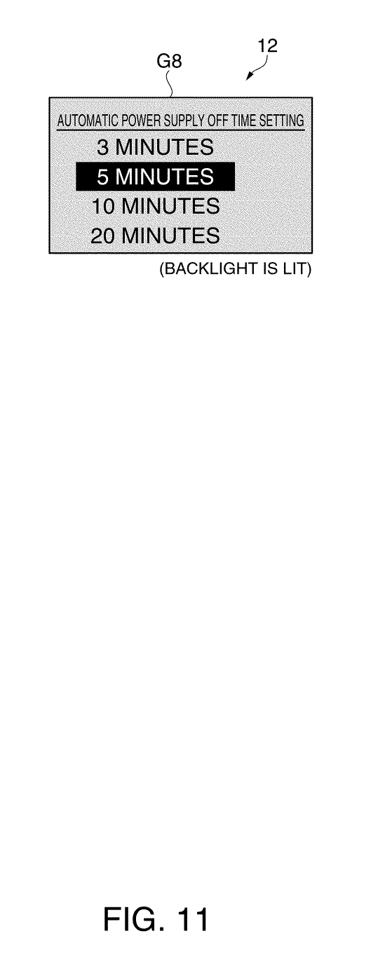

FIG. 11 is an explanatory diagram showing a second period change menu screen. In the uppermost part of a second period change menu screen G8, the character string of “AUTOMATIC POWER SUPPLY OFF TIME SETTING” indicating that this is a second period change menu is displayed. Under that character string, from the top, the character strings of “3 MINUTES”, “5 MINUTES”, “10 MINUTES”, and “20 MINUTES” are displayed as options. In the second period change menu screen G8, the part corresponding to the current setting of “5 MINUTES” is highlighted as a cursor.

When the user presses the cursor key of the keyboard 11, the highlighted cursor is moved up and down. Then, the user can set the currently highlighted option as the second period by pressing the Enter key. At this time, it is desirable that the setting be made impossible when the period of the option to be set is shorter than the first period. The control section 30 stores the set second period in the RAM 32. The control section 30 here corresponds to the period changing section. Incidentally, in this embodiment, the default of the second period is “5 MINUTES”.

The control section 30 of the tape printer 1 performs power supply OFF control in the backlight unlit state ST12 by referring to the second period stored in the RAM 32.

According to the first embodiment described above, the following effects can be obtained.

(1) When none of the keys is pressed in the character entry state ST11 even when the value measured by the timer 31a reaches the first period, the tape printer 1 switches into the backlight unlit state ST12 which is the first power-saving mode in which the backlight 46 is unlit. As a result, the backlight 46 is turned off, whereby it is possible to reduce power consumption. In particular, it is possible to prolong the battery life when the tape printer 1 is driven by the battery 51. Moreover, even when the commercial power supply 52 is used, it is possible to provide energy savings.

(2) When any of the keys is pressed in the backlight unlit state ST12, the tape printer 1 switches into the character entry state ST11 which is the normal mode in which the backlight 46 is lit. As a result, the backlight 46 is immediately turned on with a simple operation from a state in which power consumption is reduced, making it possible to improve the viewability of the display section 12.

(3) When none of the keys is pressed in the backlight unlit state ST12 even when the value measured by the timer 31a reaches the second period, the tape printer 1 switches into the standby state ST10 which is the second power-saving mode in which the power supply of the tape printer 1 is turned off. As a result, even if the user does not perform power supply OFF operation, the tape printer 1 automatically turns off the power supply. This makes it possible to make the power consumption of the tape printer 1 lower than that in the backlight unlit state ST12.

(4) In the printing state ST13, the tape printer 1 enters the first power-saving mode in which the backlight 46 is unlit . As a result, the backlight 46 is unlit while printing during which all entry operations except for the operation by the power supply key are prohibited, making it possible to reduce power consumption.

(5) The tape printer 1 can change the first period by means of the first period change menu screen G5. As a result, the user can set the period for which the backlight 46 is unlit in the character entry state ST11 at an intended period.

(6) The tape printer 1 can change settings of the backlight at the time of printing by means of the printing-time backlight setting menu screen G6. As a result, the user can arbitrarily make settings as to whether the backlight 46 is lit/unlit in the printing state ST13.

(7) The tape printer 1 can change settings of the intensity of the backlight by means of the backlight intensity setting menu screen G7. As a result, the user can arbitrarily set the intensity of the backlight 46. Moreover, by setting the intensity of the backlight 46 at a low intensity, it is possible to reduce the power consumption of the tape printer 1.

(8) The tape printer 1 can change the second period by means of the second period change menu screen G8. As a result, the user can set an intended period as the period after which the tape printer 1 automatically turns off the power supply.

### Second Embodiment

Hereinafter, a second embodiment will be described.

A tape printer 100 according to the second embodiment switches into a first power-saving mode when the tape printer 100 does not accept an entry operation for a first period, switches into a third power-saving mode when the tape printer 100 does not accept an entry operation for a third period, and switches into a second power-saving mode when the tape printer 100 does not accept an entry operation for a second period.

The appearance and mechanism of the tape printer 100 according to the second embodiment are the same as those of the tape printer 1 according to the first embodiment, and therefore descriptions thereof will be omitted. Moreover, a block diagram showing a circuit configuration of the tape printer 100 according to the second embodiment is the same as that of the tape printer 1 according to the first embodiment, and therefore descriptions thereof will be omitted.

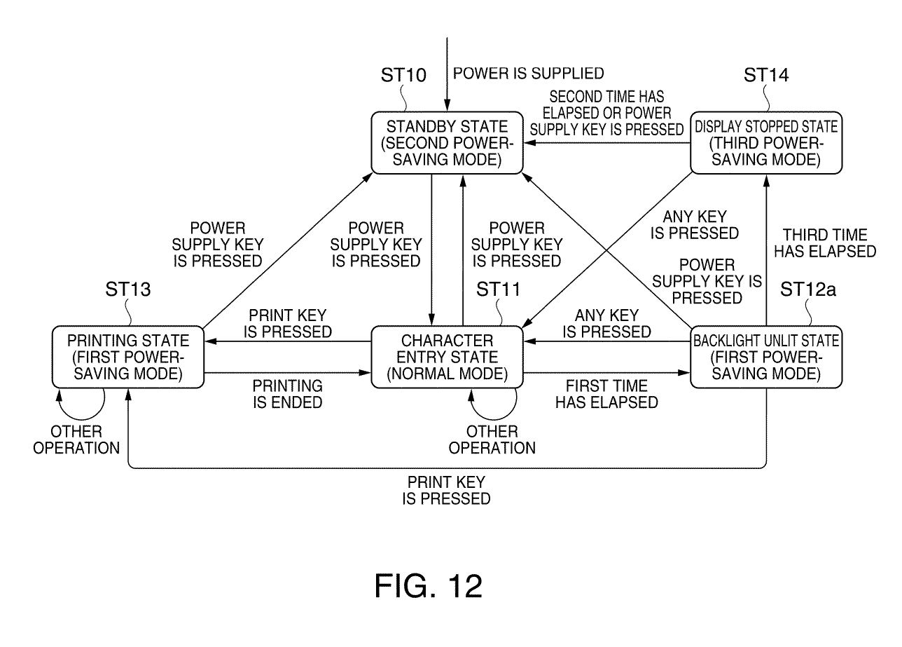

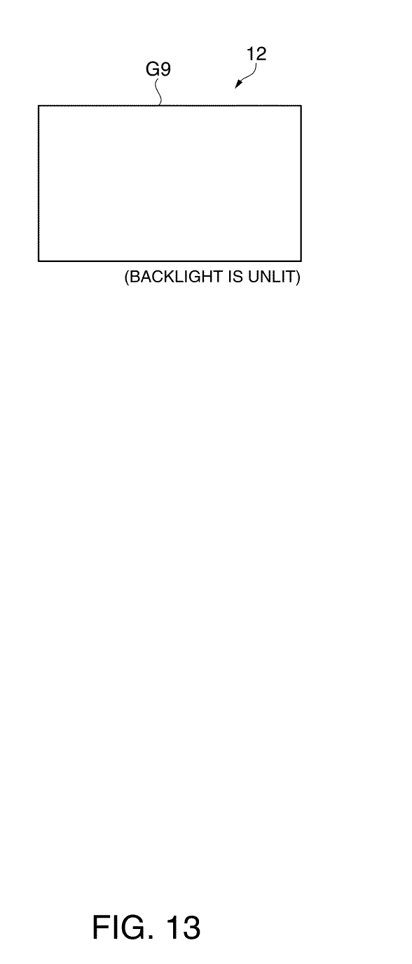

Next, a state transition of the tape printer 100 according to the second embodiment will be described by using a state transition diagram and an explanatory diagram of a screen. FIG. 12 is a state transition diagram of the tape printer 100 according to the second embodiment. FIG. 13 is an explanatory diagram showing the screen of the display section 12 in a display stopped state of the tape printer 100.

As shown in FIG. 12, the tape printer 100 can transition to a standby state ST10, a character entry state ST11, a backlight unlit state ST12a, a printing state ST13, and a display stopped state ST14.

Moreover, each state is in any one of a normal mode, a first power-saving mode, a second power-saving mode, and a third power-saving mode. As is the case with the first embodiment, in the normal mode, the power supply circuit 50 supplies power, the display section 12 performs screen display, and the backlight 46 is lit. As is the case with the first embodiment, in the first power-saving mode, the power supply circuit 50 supplies power, the display section 12 performs screen display, and the backlight 46 is unlit. As is the case with the first embodiment, in the second power-saving mode, the power supply circuit 50 stops the supply of power, the display section 12 stops screen display, and the backlight 46 is unlit. In the third power-saving mode, the power supply circuit 50 supplies power, the display section 12 stops screen display, and the backlight 46 is unlit.

When the tape printer 100 is supplied with power by the battery 51 or the commercial power supply 52, the tape printer 100 enters the standby state ST10. As is the case with the first embodiment, in the standby state ST10, the tape printer 100 is in the second power-saving mode, and waits for power supply ON operation to be performed. The state transition is also the same as that in the first embodiment.

As is the case with the first embodiment, in the character entry state ST11, the tape printer 100 is in the normal mode, and turns on the backlight 46 and accepts a character entry. The state transition is also the same as that in the first embodiment.

In the backlight unlit state ST12a, the tape printer 100 is in the first power-saving mode, and turns off the backlight 46, and accepts a character entry.

When the print key of the keyboard 11 is pressed in the backlight unlit state ST12a, the tape printer 100 transitions to the printing state ST13. Moreover, when the power supply key of the keyboard 11 is pressed in the backlight unlit state ST12a, the tape printer 100 transitions to the standby state ST10. In addition, when none of the keys is pressed and the value measured by the timer 31a exceeds the third period in the backlight unlit state ST12a, the tape printer 100 transitions to the display stopped state ST14. In this embodiment, the third period is assumed to be 2 minutes. Moreover, when any other key of the keyboard 11 is pressed in the backlight unlit state ST12a, the tape printer 100 transitions to the character entry state ST11.

The display stopped state ST14 is a state in which the tape printer 100 is in the third power-saving mode, and turns off the backlight 46 and stops display of the display section 12. In the display stopped state ST14, the display section 12 is a nondisplay screen on which nothing is displayed. As shown in FIG. 13, nothing is displayed on a nondisplay screen G9, and the backlight 46 is unlit.

When none of the keys is pressed and the value measured by the timer 31a exceeds the second period or the power supply key of the keyboard 11 is pressed in the display stopped state ST14, the tape printer 100 transitions to the standby state ST10. In this embodiment, the second period is assumed to be 5 minutes. Moreover, when any other key of the keyboard 11 is pressed in the display stopped state ST14, the tape printer 100 transitions to the character entry state ST11.

As is the case with the first embodiment, in the printing state ST13, the tape printer 100 is in the first power-saving mode, and turns off the backlight 46 and performs printing. The state transition is also the same as that in the first embodiment.

Next, processing in each state of the tape printer 100 will be described.

The processing in the standby state ST10, the character entry state ST11, and the printing state ST13 is the same as that in the first embodiment, and therefore descriptions thereof will be omitted.

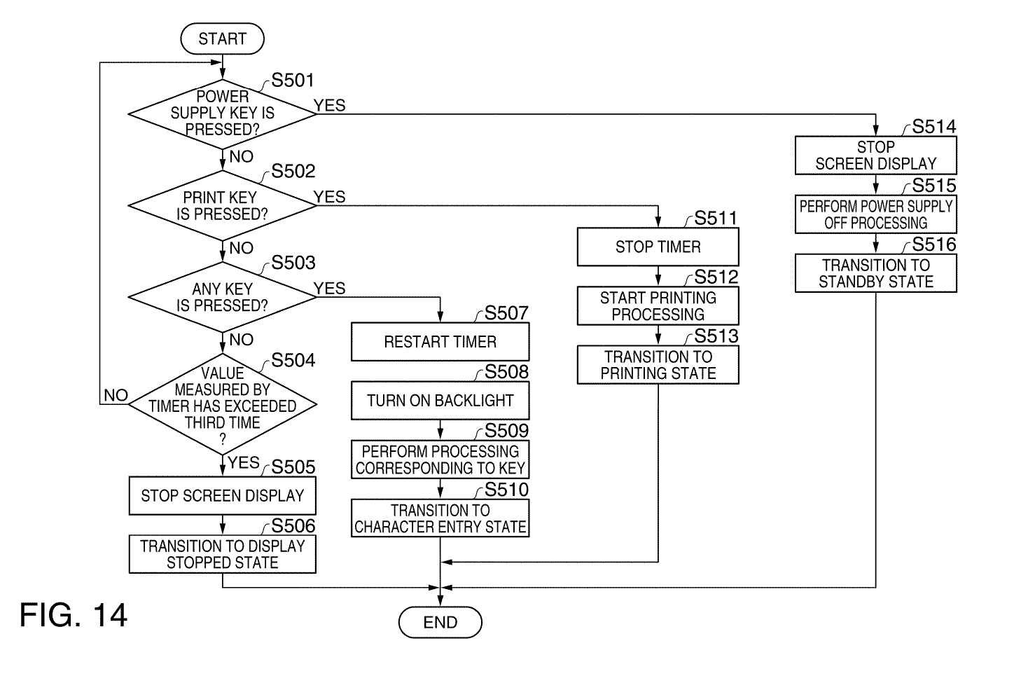

FIG. 14 is a flowchart of processing in the backlight unlit state ST12a of the tape printer 100.

In the backlight unlit state ST12a, the control section 30 determines whether or not the power supply key of the keyboard 11 is pressed to perform power supply OFF operation (step S501). If the power supply key is not pressed (step S501: NO), the control section 30 determines whether or not the print key of the keyboard 11 is pressed (step S502). If the print key is not pressed (step S502: NO), the control section 30 determines whether or not any of the keys of the keyboard 11 is pressed (step S503).

If none of the keys is pressed (step S503: NO), the control section 30 determines whether or not the value measured by the timer 31a has exceeded the third period (step S504). If the value has not exceeded the third period (step S504: NO), the procedure goes back to step S501.

If the value has exceeded the third period (step S504: YES), the display driving section 41 stops (turns off) screen display (step S505) . Then, the control section 30 makes the tape printer 100 transition to the display stopped state ST14 (step S506). In addition, the control section 30 ends the processing of the tape printer 100 in the backlight unlit state ST12a.

When any of the keys is pressed (step S503: YES), the control section 30 restarts the timer 31a (step S507) . Then, the control section 30 gives an instruction to the backlight driving section 45, and turns on the backlight 46 (step S508).

The control section 30 performs processing corresponding to the pressed key (step S509). Then, the control section 30 makes the tape printer 100 transition to the character entry state ST11 (step S510). Then, the control section 30 ends the processing of the tape printer 100 in the backlight unlit state ST12a.

If the print key is pressed (step S502: YES), the control section 30 stops the timer 31a (step S511). Then, the control section 30 starts printing processing based on the entered character string (step S512). The control section 30 then makes the tape printer 100 transition to the printing state ST13 (step S513). Then, the control section 30 ends the processing of the tape printer 100 in the backlight unlit state ST12a.

If the power supply key is pressed (step S501: YES), the display driving section 41 stops screen display (step S514). Next, the control section 30 performs power supply OFF processing (step S515). Then, the control section 30 makes the tape printer 100 transition to the standby state ST10 (step S516). Then, the control section 30 ends the processing of the tape printer 100 in the backlight unlit state ST12a.

Next, processing in the display stopped state ST14 will be described.

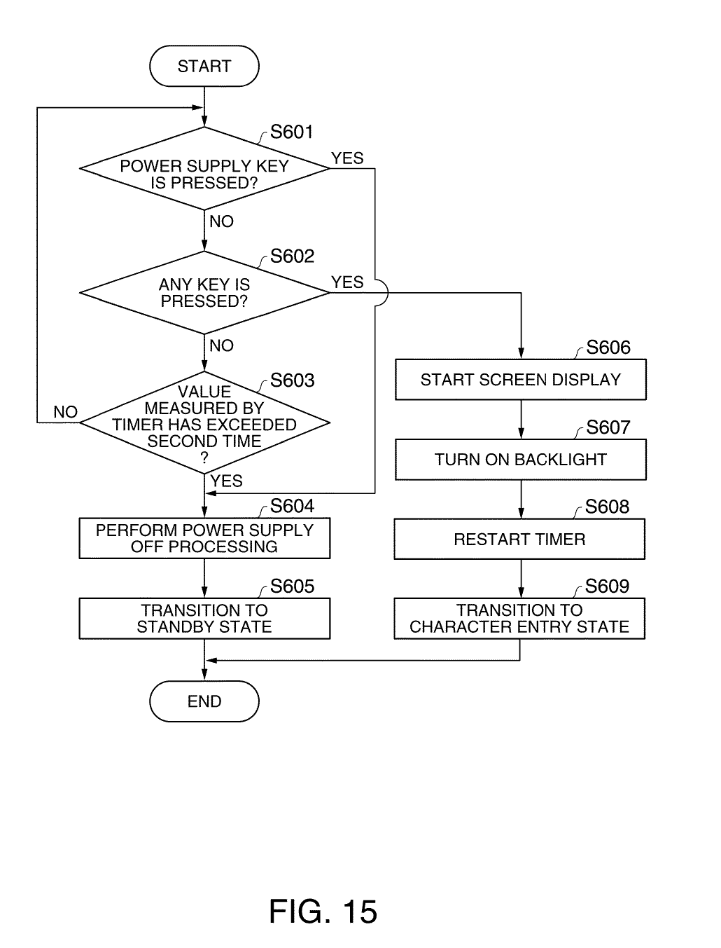

FIG. 15 is a flowchart of processing in the display stopped state ST14 of the tape printer 100.

In the display stopped state ST14, the control section 30 determines whether or not the power supply key of the keyboard 11 is pressed to perform power supply OFF operation (step S601). If the power supply key is not pressed (step S601: NO), the control section 30 determines whether or not any of the keys of the keyboard 11 is pressed (step S602).

If none of the keys is pressed (step S602: NO), the control section 30 determines whether or not the value measured by the timer 31a has exceeded the second period (step S603). If the value has not exceeded the second period (step S603: NO), the procedure goes back to step S601.

If the value has exceeded the second period (step S603: YES), the control section 30 performs power supply OFF processing (step S604). Then, the control section 30 makes the tape printer 100 transition to the standby state ST10 (step S605). Then, the control section 30 ends the processing of the tape printer 100 in the display stopped state ST14.

If any of the keys is pressed (step S602: YES), the control section 30 gives an instruction to the display driving section 41, and makes the display section 12 start screen display (step S606). Then, the backlight driving section 45 turns on the backlight 46 (step S607). Next, the control section 30 restarts the timer 31a (step S608). Then, the control section 30 makes the tape printer 100 transition to the character entry state ST11 (step S609). Then, the control section 30 ends the processing of the tape printer 100 in the display stopped state ST14.

If the power supply key is pressed (step S601: YES), the procedure proceeds to step S604, and the control section 30 performs power supply OFF processing and makes the tape printer 100 transition to the standby state ST10. Then, the control section 30 ends the processing of the tape printer 100 in the display stopped state ST14.

As described above, the tape printer 100 can transition to/from the standby state ST10, the character entry state ST11, the backlight unlit state ST12a, the printing state ST13, and the display stopped state ST14.

Next, various settings related to the backlight 46 of the tape printer 100 will be described. As is the case with the tape printer 1 of the first embodiment, in the tape printer 100 of the second embodiment, it is possible to select and set the first period by displaying the first period change menu screen G5. Moreover, as is the case with the tape printer 1 of the first embodiment, in the tape printer 100, it is possible to make settings as to whether or not to turn on the backlight 46 in the printing state ST13 by displaying the printing-time backlight setting menu screen G6. Furthermore, as is the case with the tape printer 1 of the first embodiment, in the tape printer 100, it is possible to select and set the intensity of the backlight 46 by displaying the backlight intensity setting menu screen G7.

Moreover, as is the case with the tape printer 1 of the first embodiment, in the tape printer 100, it is possible to select and set the second period by displaying the second period change menu screen G8.

Furthermore, in the tape printer 100 of this embodiment, it is also possible to select and set the third period. As is the case with the first period change menu screen G5 of the first embodiment, the tape printer 100 can make the display section 12 display the third period change menu screen, and allow the user to select and set an intended period.

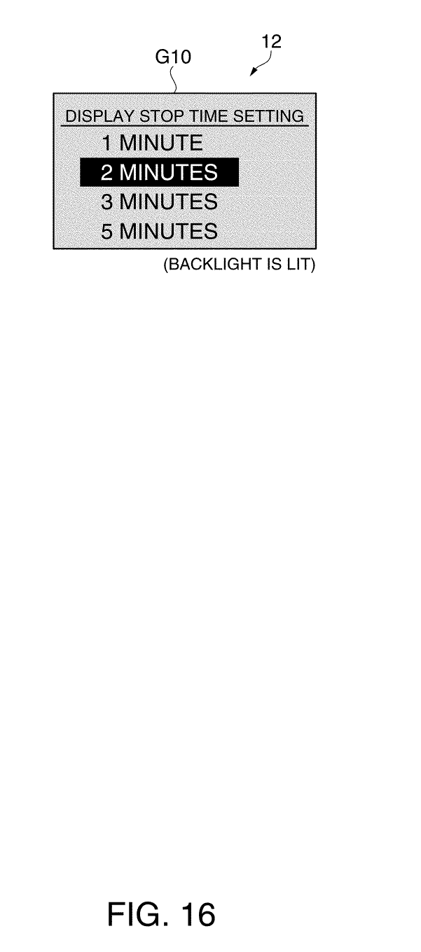

FIG. 16 is an explanatory diagram showing a third period change menu screen. In the uppermost part of a third period change menu screen G10, the character string of “DISPLAY STOP TIME SETTING” indicating that this is a third period change menu is displayed. Under that character string, from the top, the character strings of “1 MINUTE”, “2 MINUTES”, “3 MINUTES”, and “5 MINUTES” are displayed as options. In the third period change menu screen G10, the part corresponding to the current setting of “2 MINUTES” is highlighted as a cursor.

When the user presses the cursor key of the keyboard 11, the highlighted cursor is moved up and down. Then, the user can set the currently highlighted option as a third period by pressing the Enter key. At this time, it is desirable that the setting be made impossible when the period of the option to be set is shorter than the first period or longer than the second period. The control section 30 stores the set third period in the RAM 32. The control section 30 here corresponds to the period changing section. Incidentally, in this embodiment, the default of the third period is “2 MINUTES”.

The control section 30 of the tape printer 100 controls screen display of the display section 12 in the backlight unlit state ST12a by referring to the third period setting stored in the RAM 32 in the manner as described above.

According to the second embodiment described above, the effects similar to the effects (4), (5), (6), (7), and (8) of the first embodiment can be obtained. In addition to these effects, the following effects can be obtained.

(1) When none of the keys is pressed even when the value measured by timer 31a reaches the first period in the character entry state ST11, the tape printer 100 switches into the backlight unlit state ST12a which is the first power-saving mode in which the backlight 46 is unlit. As a result, the backlight 46 is turned off, making it possible to reduce power consumption. In particular, it is possible to prolong the battery life when the tape printer 100 is driven by the battery 51. Moreover, even when the commercial power supply 52 is used, it is possible to provide energy savings.

(2) When any of the keys is pressed in the backlight unlit state ST12a, the tape printer 100 switches into the character entry state ST11 which is the normal mode in which the backlight 46 is lit. As a result, the backlight 46 is immediately turned on with a simple operation from a state in which power consumption is reduced, making it possible to improve the viewability of the display section 12.

(3) When none of the keys is pressed even when the value measured by the timer 31a reaches the third period in the backlight unlit state ST12a, the tape printer 100 switches into the display stopped state ST14 which is the third power-saving mode in which the screen display of the tape printer 100 is stopped. As a result, since the screen display of the tape printer 100 is stopped (turned off), it is possible to make the power consumption lower than that in the backlight unlit state ST12a without turning off the power supply of the tape printer 100.

(4) When any of the keys is pressed in the display stopped state ST14, the tape printer 100 starts screen display, and switches into the character entry state ST11 which is the normal mode in which the backlight 46 is lit. This makes it possible to resume a character entry at once with a simple operation from a state in which power consumption is reduced.

(5) When none of the keys is pressed even when the value measured by the timer 31a reaches the second period in the display stopped state ST14, the tape printer 100 switches into the standby state ST10 which is the second power-saving mode in which the power supply of the tape printer 100 is turned off. As a result, even if the user does not perform power supply OFF operation, the tape printer 100 automatically turns off the power supply. This makes it possible to make the power consumption of the tape printer 100 lower than that in the display stopped state ST14.

Moreover, the embodiments described above can also be configured as a recording medium etc. which records a program product for realizing the above functions in such a way that the program product can be read by a computer. As the recording medium, various media that can be read by the computer, the media such as a flexible disk and a hard disk, an optical disk such as a CD and a DVD, a magneto-optical disk, a memory card and USB memory which incorporate nonvolatile semiconductor memory, and internal memory (semiconductor memory such as RAM and ROM) of an image generating apparatus, can be used.

The invention is not limited in any way by the embodiments thereof described above, and many variations and modifications are possible. Modified examples will be described below.

### Modified Example 1

In the embodiments described above, the backlight 46 is formed of an LED; however, the invention is not limited to the LED. Other lamps or an organic EL may be used.

Modified Example 2

In the embodiments described above, the backlight 46 is provided on the back of the display section 12; however, the display section 12 may be illuminated from another direction. For example, the display section 12 may be illuminated from the side thereof.

Modified Example 3

In the embodiments described above, the backlight 46 illuminates the display section 12. Here, each key of the keyboard 11 may be an illuminated key switch incorporating an LED as an illuminating device, and the LED incorporated in the illuminated key switch may be turned on/off according to the timing with which the backlight 46 is turned on/off. Doing so improves the viewability of the keyboard 11, and makes it possible to reduce power consumption in each power-saving mode.

### Modified Example 4

In the embodiments described above, the first period change menu screen G5, the second period change menu screen G8, and the third period change menu screen G10 display two or more period options, and make the user make a selection. However, instead of displaying two or more period options, a screen (not shown) accepting an arbitrary period entry may be displayed. For example, the user may be allowed to set an arbitrary period by pressing the numeric key and the Enter key of the keyboard 11.

### Modified Example 5

In the embodiments described above, the backlight intensity setting menu screen G7 displays three options: “DARK”, “NORMAL”, and “BRIGHT”, and makes the user make a selection. However, the invention is not limited to an embodiment in which three options are displayed. For example, the intensity of the backlight 46 may be expressed as a numeric value, and the user may be allowed to set an arbitrary intensity by pressing the numeric key and the Enter key of the keyboard 11.

### Modified Example 6

In the embodiments described above, when any of the keys is pressed in the backlight unlit states ST12 and ST12a, processing corresponding to the pressed key is performed, and the state transitions to the character entry state ST11. However, the state may transition to the character entry state ST11 without processing corresponding to the pressed key.

### Modified Example 7

In the second embodiment described above, when any of the keys is pressed in the display stopped state ST14, the state transitions to the character entry state ST11 without processing corresponding to the pressed key. However, the state may transition to the character entry state ST11 after processing corresponding to the pressed key is performed.

### Modified Example 8

In the embodiments described above, as a printing method for printing a character etc. on the tape T, a thermal transfer method by the thermal head 15 is used; however, the invention is not limited thereto. Other printing methods such as an ink-jet method by which an ink drop is discharged may be used.

What is claimed is:

1. A tape printer printing an image on a tape, the tape printer comprising:
an operation accepting section accepting an entry operation;
a display section performing screen display based on the entry operation accepted by the operation accepting section;
an illuminating section illuminating the display section;
a control section controlling the operation of the tape printer; and
a printing section printing the image based on an entered character string on the tape,
wherein
while the printing section performs printing based on the entry operation, the control section switches a mode to a first power-saving mode in which the illuminating section is turned off.

2. The tape printer according to claim 1, further comprising:
a power supply circuit switching a power supply of the tape printer on and off,
wherein
the control section switches a mode to the first power-saving mode in which the illuminating section is turned off when the operation accepting section does not accept any entry operation for a first period, and switches a mode to a second power-saving mode in which the power supply of the power supply circuit is turned off when the operation accepting section does not accept any entry operation for a second period which is longer than the first period.

3. The tape printer according to claim 1, wherein
the control section switches a mode to a third power-saving mode in which the screen display of the display section is stopped when the operation accepting section does not accept any entry operation for a third period which is longer than the first period and shorter than the second period.

4. The tape printer according to claim 3, further comprising:
a period changing section changing at least one of the first period, the second period, and the third period according to a predetermined entry operation accepted by the operation accepting section.

5. A method for controlling a tape printer including a display section performing screen display based on an entry operation, an illuminating section illuminating the display section, and a printing section printing an image based on an entered character string on a tape, the method comprising:
(a) accepting an entry operation;
(b) switching a mode to the first power-saving mode in which the illuminating section is turned off, while the printing section prints the image based on the entry operation.

6. The method according to claim 5, further comprising:
(c) switching a mode to the first power-saving mode in which the illuminating section is turned off when no entry operation is accepted for the first period in the step (a); and
(d) switching a mode to a second power-saving mode in which the power supply of the power supply circuit is turned off when no entry operation is accepted for a second period in the step (a), the second period which is longer than the first period.

7. The method according to claim 6, further comprising:
(e) switching a mode to a third power-saving mode in which the screen display of the display section is stopped when the step (a) does not accept any entry operation for a third period which is longer than the first period and shorter than the second period.

8. The method according to claim 7, further comprising:
(f) changing at least one of the first period, the second period, and the third period according to a predetermined entry operation accepted by the step (a).

9. A computer program product for making a computer execute the steps of the method for controlling a tape printer according to claim 5.
